(19) United States
(12) Patent Application Publication
(10) Pub. No.: US 2011/0011099 A1
(43) Pub. Date: Jan. 20, 2011

(54) COMPACT COUNTERTOP COOLER

(76) Inventor: NATHAN LINDER, Encinitas, CA (US)

Correspondence Address: STETINA BRUNDA GARRED & BRUCKER, 75 ENTERPRISE, SUITE 250, ALISO VIEJO, CA, 92656, US

(21) Appl. No.: 12/506,110

(22) Filed: Jul. 20, 2009

(51) Int. Cl. F25B 21/02; A47F 3/04; G07F 9/10; G09F 11/00

(52) U.S. Cl. 62/3.6; 62/249; 62/251; 221/150 R; 40/1

(57) ABSTRACT

A compact, countertop cooler for use in dispensing cold, energy-shot beverages at point-of-purchase retail locations. The cooler comprises a housing operative to store and selectively dispense individual containers of beverages through a gravity feed system. Preferably, the cooler will include an outwardly-facing window to facilitate the consumer's ability to see the contents and further, will preferably include a ratchet-type dispensing system to selectively dispense each beverage container individually so as to serve as an anti-theft mechanism, and further dispense at least one and preferably two containers of dissimilar size. The housing will further include a cooling system to provide cooling for the beverages and further, may be provided with decorative indicia to facilitate advertising and the display of product information.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is directed to a compact, countertop cooler for use in the merchandising and dispensation of beverages at point of purchase retail locations. More specifically, the present invention is directed to a cooler uniquely adapted to dispense energy-shot type beverages having dissimilar container sizes that further includes a ratchet-type vending mechanism that selectively dispenses individual beverage containers so as to serve as an anti-theft device.

Providing chilled beverages at point of purchase locations is a well-known and widely-accepted practice. In this regard, providing easy and immediate access to such beverages greatly enhances the probability that such beverages will be purchased on impulse. This phenomenon can especially be appreciated in periods of hot weather where thirsty customers can essentially attain instant gratification simply due to the ease by which chilled beverages are made accessible.

Despite the incredible effectiveness to promote impulse purchases of chilled beverages at point of purchase retail locations, significant problems exist with respect to the prior art methods and systems by which chilled beverages are provided. Perhaps the most widespread and well-known of such practices include providing beverages in barrels filled with ice that simply enable a customer to grab and pull out a chilled beverage. Such systems, however, suffer from numerous drawbacks, including the need to continuously replenish the supply of ice, as well as remove or drain the water that is produced from the melted ice. In addition, such systems require the user to stick their hands into the ice, which may be undesirable for the consumer, cause ice/water to be spilled about the beverage display, and can further increase the unsightliness/uncleanliness of the beverage display by virtue of the fact that multiple consumers are continuously reaching in, handling and sorting through beverages and ice-slurry. Along those lines, by virtue of the fact that the beverages are continuously immersed in ice and ice slurry, the labeling associated with such beverage containers can and frequently does become unsightly and unpleasing to the consumer.

Alternatively, open door-type coolers may be provided that enable the consumers to readily obtain a chilled beverage from a refrigerated-type device. Problematic with such open-door coolers, however, is the fact that the same are not generally space efficient and cannot be positioned in a manner that is at or slightly below the consumer's eye level, which is typically desired to facilitate impulse purchases. Moreover, because such coolers require a closed environment to maintain the beverages in a chilled state, the repetitious opening and closing of the cooler doors create a loss of cooling and thus requires that a greater amount of energy be utilized to maintain the beverages in their cooled state.

The foregoing drawbacks of both conventional ice barrels and open door coolers are especially problematic with energy-shot beverages that typically have a smaller container size and are only a few ounces in volume compared to conventional beverage containers utilized for water, soft drinks, beer, sports drinks, and the like. In this regard, the smaller container size associated with such energy-shot beverages allow for substantially more space efficient storage and display which unfortunately are not met by the aforementioned conventional point-of-purchase systems. Further compounding such problem is the fact that energy-shot beverages come in a wide variety of container sizes and there is not any accepted type of conventional container size associated with such beverage products, as opposed to 12 ounce cans for soft drinks and the like. Indeed, there has not yet been available any means for readily dispensing energy-shot beverages as marketed having dissimilar container sizing.

An additional problem associated with prior art systems for providing chilled beverages at point-of-purchase locations is the fact that such systems do not readily deter theft. In this regard, by providing ease of accessibility to such chilled beverages, such beverages may easily be stolen or hidden from view from cashiers and other retail workers. This latter phenomenon is especially prevalent with respect to the energy-shot beverages discussed above due to their smaller container size that, consequently, enables such beverages to be more readily concealed and stolen.

Accordingly, there is a substantial need in the art for a cooler, and in particular a compact, countertop cooler that is specifically designed and configured to facilitate the easy and immediate accessibility to chilled beverages at a point-of-purchase location that avoids the aforementioned deficiencies in the prior art. There is especially a need for such cooler that can be configured to facilitate the immediate and easy accessibility to energy-shot beverages or beverages having smaller, more compact container sizes, including dispensing containers having dissimilar sizes, that further not only can enhance the visibility and visual display of such beverages, but further can selectively dispense such beverages in a manner that conserves the refrigerated state within the cooler while also being operative to serve as an anti-theft device. There is still further a need in the art for such a cooler that has an aesthetically pleasing appearance, can provide sufficient cooling capability, can be utilized to facilitate the display and advertising of the beverages contained therein, can be made to be light weight, durable and exceptionally easy to use, and most importantly facilitate the purchase of beverages at point-of-purchase retail locations.

### BRIEF SUMMARY

The present invention specifically addresses and alleviates the above-identified deficiencies in the art. In this regard, the present invention is directed to a compact countertop cooler for use in dispensing cold beverages at point-of-purchase retail locations. The present invention may further be specifically designed and adapted to dispense cold energy-shot beverages and further, may be operative to independently cool and dispense two separate dissimilarly sized bottles at the same time. Still further, the cooler of the present invention is operative to substantially deter theft of the beverages stored therein and may further be designed in a space efficient, aesthetically pleasing manner that can be utilized to enhance the display of the beverages being sold and dispensed therefrom, as well as provide means for advertising, product promotion and the like.

According to a preferred embodiment, the cooler of the present invention comprises a housing preferably having a front transparent display, at least one, and preferably two independent gravity-feed beverage dispensing systems, a cooling system, which preferably comprises a thermoelectric heat pump type of device for cooling that is integrated within said housing, and a lid member to allow access to the interior of the cooler for purposes of refilling the cooler with beverages and forming a closure about the cooler to thus conserve refrigeration.

Integrated as part of each gravity-feed dispenser system is a vending mechanism having a ratchet-type dispenser defining a vending chamber that selectively dispenses individual beverage containers. Preferably, such ratchet-type dispenser provides a perceptible signal, such as a sound alert, by ratcheting or other mechanical or electrical/mechanism that is activated when the ratchet mechanism is rotated, which will be necessary for the customer to do in order to gain access to the desired beverage. Preferably, the ratchet-type dispenser will be audible and thus be indicative that an individual container is being dispensed (as opposed to merely being taken per conventional point-of-purchase beverage cooler systems).

The cooler of the present invention may be sized and configured to fit easily upon a countertop and be maintained at or slightly below the eye level of the consumer to thus facilitate the ability of the cooler to inspire an impulse purchase. Additionally, by virtue of the ratchet-type dispenser mechanism, not only is theft deterred but the ability of the cooler to preserve the refrigerated state is maximized as such vending mechanism minimizes the open area and time the interior of the cooler is exposed to the ambient environment, unlike open-door type coolers.

Still further, by virtue of being capable of dispensing two separate, dissimilarly-sized beverage containers at the same time, the cooler of the present invention can be utilized to provide a variety of beverages to the consumer. Moreover, the cooler of the present invention is operative to accommodate a wide range of bottle sizes and further may be expressly configured to accommodate bottle sizes with minimal modification and preferably without the need to remove or add parts.

### BRIEF DESCRIPTION OF THE DRAWINGS

These as well as other features of the present invention will become more apparent upon reference to the drawings.

FIG. 1 is a perspective view of a compact countertop cooler constructed in accordance with a preferred embodiment of the present invention.

FIG. 2 is a perspective, cross-sectional view of the interior of the cooler depicted in FIG. 1 further showing the cooling mechanism and gravity feed dispensing system incorporated as part of said cooler.

FIG. 3 is a partial cross-sectional view of a vending mechanism utilizing a ratchet-type dispenser as used in the practice of the present invention to individually dispense beverage containers stored within the housing of said cooler.

FIG. 4 is a spectrum of conventional beverage containers that may be displayed and dispensed via the countertop cooler of the present invention.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

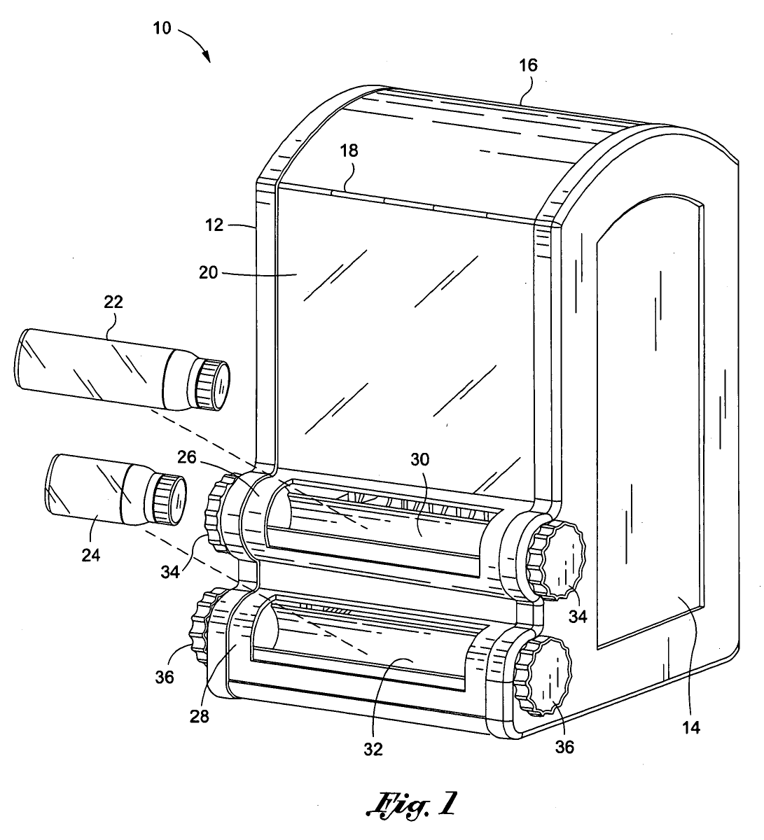

Referring to the Figures now, and initially to FIG. 1, there is perspectively illustrated a compact, countertop cooler 10 that is operative to dispense individual bottles of beverages at point-of-purchase retail locations. The cooler 10 is further operative to deter the theft of such beverages and, in the embodiment show, can be utilized to separately dispense individual bottles of two dissimilarly sized containers. Such cooler 10 is provided with a plurality of features that are novel and are believed not to be disclosed or taught in the prior art.

As shown, the cooler 10 comprises a housing 12 defining an interior, discussed more fully below, to house a plurality of beverage containers. The housing 12 will be provided with panel portions, such as side panel 14 that may be designed and configured to receive or display decorative indicia, product logos, advertising, and the like. The house 12 further includes a lid portion 16 that rotates about hinge 18, which provides means for accessing the interior of the housing 12. The housing 12 is further preferably provided with a transparent front window 20 to enable consumers to see the contents within the housing 12, which is operative to not only provide information to the consumer regarding the type and brand of product contained within the cooler 10, but also can serve to identify the inventory of beverage containers stored within the cooler 10 to the extent the same needs to be replenished.

The cooler 10 is further provided with means for individually dispensing containers for a particular type and/or brand of beverage. As shown, first vending mechanism 26 is operative to selectively isolate and make accessible to a consumer a beverage container 22. To that end, the first vending mechanism 26 is provided with a first vending chamber 30 that preferably includes a C-shape, discussed more fully below, that enables an individual container 22 to be captured and presented to the consumer via the use of a manually operable ratchet knob 34. In this respect, the vending chamber 30 is formed to have a generally cylindrical shape operative to isolate a container coaxially therewithin.

To further enhance the ability of the cooler 10 to dispense a second type or size container, such as 24, there is provided a second vending mechanism 28 that is similar in design and structure to first vending mechanism 26. In this regard, there is likewise provided a generally C-shaped vending chamber 32 that is operative to selectively isolate an individual beverage container 24 via manually operable ratchet knob 36. As will be appreciated by those skilled in the art, and as discussed more fully below, the cooler 10 advantageously provides means for easily and selectively accessing not just one, but two dissimilar sized beverage containers. As will be appreciated in the art and as discussed more fully below, it is further contemplated that the cooler 10 of the present invention can easily be configured and adapted to dispense three, four, five or more dissimilarly shaped containers if desired.

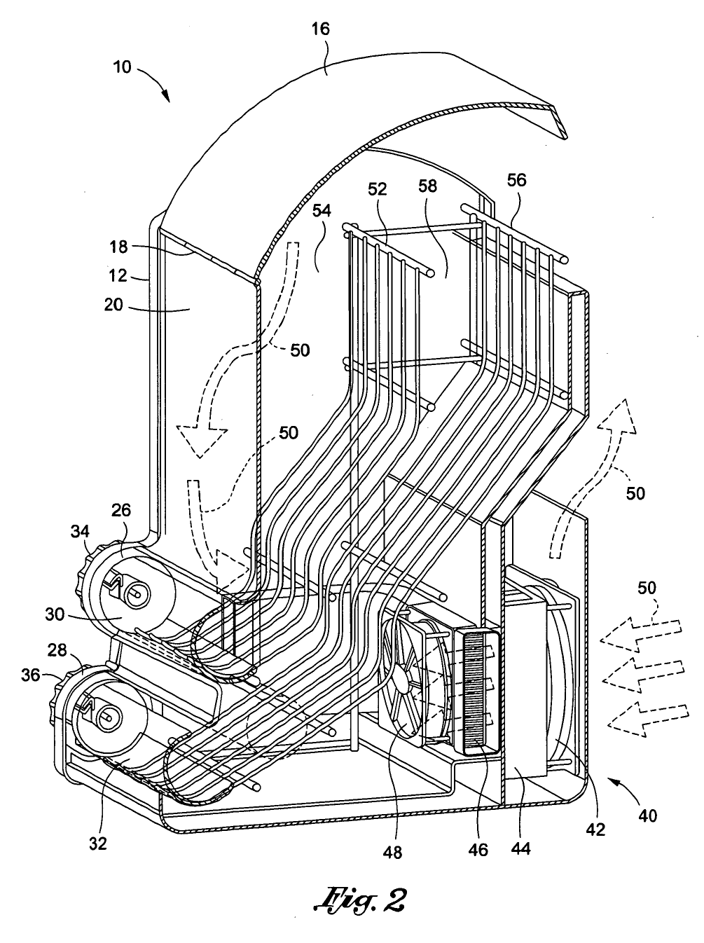

To that end, and referring now to FIG. 2, there is perspectively illustrated the interior of the housing 12 of the cooler 10 of the present invention. As illustrated, lid 16 will be able to rotate about hinge 18 to thus gain access to the interior of the housing 12 to thus enable the beverage containers to be loaded therewithin. To that end, and to allow two dissimilar beverage containers to be selectively dispensed through the dedicated vending mechanisms and vending chambers, there will be provided first and second gravity feed rack partitions 52, 56 that are operative to define discrete storage areas 54, 58 within which like sized containers may be stored and ultimately individually dispensed via a gravity feed system. In this regard, first rack partition 52 is operative to define storage area 54. Given the downward sloping configuration of first rack partition 52, which is preferably formed from a wire frame as shown, the containers will be biased via gravity in a path towards vending chamber 30 of vending mechanism 26. Advantageously, by forming the first rack partition 52 in the manner so described causes the plurality of beverage containers stored within area 54 to assume generally horizontal configurations that complement and feed into the vending chamber 30 within which each beverage container will be individually dispensed. As will be appreciated by those skilled in the art, the width of the rack partition 52 may be formed to have a desired height and width so as to accommodate beverage containers up to a particular size. Ideally, by virtue of the cylindrical nature of the vending chamber 30 of vending mechanism 26 as shown, it is believed that the cooler 10 will be best adapted to dispense beverage containers having a generally cylindrical configuration, such as bottles, cans and the like. Notwithstanding, it is believed that cooler 10 of the present invention may be adapted to dispense containers having other shapes and sizes.

To provide for the dispensation of a second dissimilar sized container, second rack partition 56 is provided that extends behind first rack/partition 52 via a sufficient distance to create space 58 that, similar to space 54, is configured to hold and selectively dispense, via gravitational feed system, individual containers through second vending chamber 32 of second vending mechanism 28. In this regard, a container stored within the area 58 will be biased or fed to second vending chamber 32 via a gravitational feed system whereby second rack partition 56 is operative to selectively guide individual containers in a path towards the second vending chamber 32. As shown, and as will be readily appreciated by those skilled in the art, in order to selectively isolate and dispense dedicated ones of containers stored within areas 54, 58, there will preferably be provided dedicated manually operable ratchet knobs 34, 36 integrated as part of the vending mechanisms 26, 28 that enable the vending chambers 30, 32 to selectively capture and make accessible to the consumer individual containers stored within holding areas 54, 58. In this regard, beverage containers stored within holding area 54 will be caused to be fed individually into vending chamber 30 whereby rotation of first ratchet knob 34 will enable the vending chamber to selectively isolate and present to the consumer a first beverage container whereas a beverage container stored within area 58 will be gravity fed into second vending chamber 32, whereby actuation of second ratchet knob 36 will cause individual ones of those containers stored within area 58 to be selectively isolated and presented to the consumer. Advantageously, by providing window 20, the consumer will thus be afforded the opportunity to see the type and brand of beverage container stored within at least area 54 and further, can provide a visual indication of the inventory stored within housing 12.

In order to facilitate the ability of the cooler 10 to maintain beverages in a refrigerated state, the same will include a cooling system 40 that is integrated within housing 12. To that end, it is contemplated that cooling system 40 may take any of a variety of well-known refrigeration systems that are commercially available. Preferably, the cooling using 40 will comprise a thermoelectric heat pump and preferably be operable to cool beverages stored within housing 12 within the temperature range of 30-40 degrees Fahrenheit. Such cooling system will further preferably be operable to attain this refrigerated range of 30-40 degrees Fahrenheit within one house of being loaded with room temperature beverage containers at 77 degrees Fahrenheit. To that end, it is contemplated that the cooling system 40 will include componentry that is nested within the base of the housing 12 at the rear-most position thereof. Per conventional cooling mechanisms, there will preferably be provided an inlet fan 42 operative to draw in ambient air 50, heat pump mechanism 44 coupled to heat sink or heat dissipater 46, the latter being operatively interconnected with a cooling fan 48 that is operative to circulate cool air within the interior of housing 12, whereas heated air generated from the heat exchange is vented away from the rear portion of the interior 12. As will be readily appreciated by those skilled in the art, however, a variety of configurations may be conceived whereby a cooling system 40 is integrated within such cooler 10 so as to provide optimal cooling of the beverage containers stored therewithin.

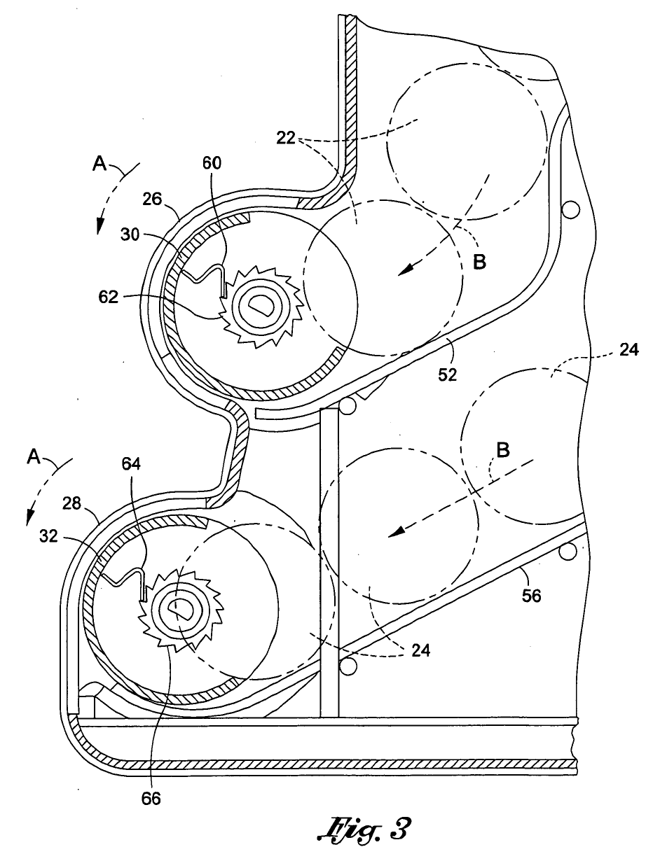

Referring now to FIG. 3, there are shown the dedicated vending paths by which each group of common product containers 22, 24 will be independently dispensed through dedicated vending mechanisms 26, 28. As discussed above, first rack partition 52 will be operative to isolate and gravitationally feed dedicated ones of containers 22 via direction “B” into a vending chamber 30 defined by a generally C-shaped cylindrical member operative to define an opening within which a single container may be received. To achieve that end, as well as to provide an anti-theft mechanism, a ratchet system comprised of cam 60 and ratchet wheel 62, the latter being connected to manually rotatable knob 34 shown in FIGS. 1 and 2, will be operative to provide an uni-directional rotation in the direction “A” that will dispense one container 22 for every 360° of rotation of the vacant vending chamber 30. If a container 22 remains in the dispensing mechanism and the vending chamber is rotated 360°, the vending mechanism advantageously shall not jam or otherwise cause difficulty with the subsequent operation of the unit insofar as the chamber 30, by virtue of being occupied with a container 22, will prevent further containers 22 from entering therein.

In further refinements of the present invention, it is contemplated that the combination of cam 60 with ratchet wheel 62 may be operative to generate a mechanical or electromechanical signal, sound or the like to thus provide an alert that the cooler 10 is being utilized, presumably by a consumer, to access one of the beverages contained therewithin. As such, a warning or alert will be provided every time the vending mechanism is utilized which thus prevents the drawbacks of prior art systems that basically rely upon the customer “honor system” whereby the customer is expected to remove a chilled beverage and present it to the cashier for purchase. Of still further advantage, by virtue of the fact that the vending mechanism 26 is capable of being operated via a manual ratchet knob 34, the vending mechanism 26 can be readily and easily utilized by one hand of the consumer, thus facilitating the ability to easily and readily use the cooler 10 of the present invention.

The same dynamics and structure are equally applicable to second vending mechanism 28. In this regard, containers stored within area 58 will be fed via gravitational pull to the second vending chamber 32 as guided by second rack partition 56. The containers will thus be fed sequentially and individually into the second vending chamber 32 in the direction indicated by the letter “B”. In this regard, as the consumer manually operates the ratchet system, the vending mechanism will be operative to receive dedicated ones of the beverage container 22 within vending chamber 32, which are thus made accessible on a container-by-container basis. Per the first vending mechanism 26, it is contemplated that the mechanism will dispense one bottle for every 360° of rotation indicated by the letter “A”. Moreover, it is contemplated that a cam 64 and ratchet wheel 66 combination may be implemented that is operative to provide an audible and/or visual signal indicating that the vending mechanism is in use to dispense a beverage container 22 so as to alert the cashier and prevent potential theft. Similarly, the vending mechanism 28 will be operable with one hand by virtue of being provided with manually operated ratchet mechanisms, such as 36 shown in FIGS. 1 and 2.

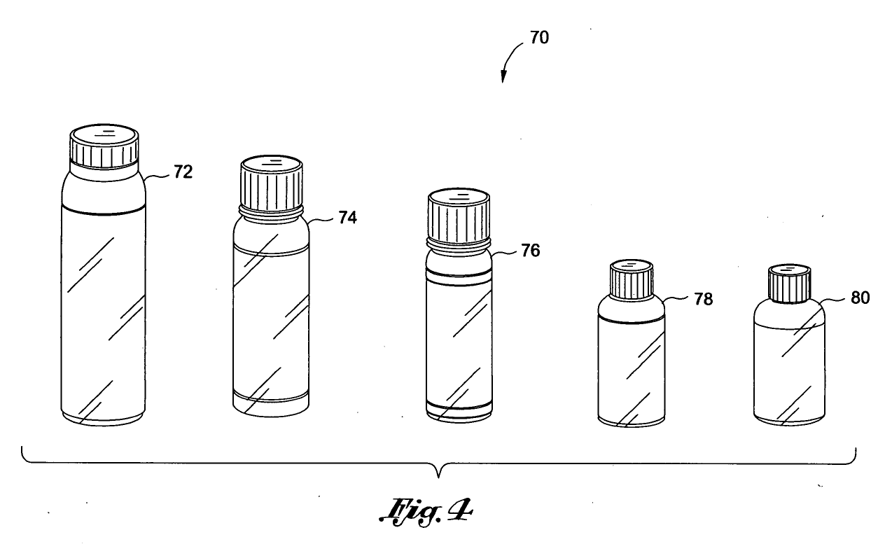

Storage areas 54, 58 within the interior of housing 12 and the dedicated vending paths by which containers stored within such areas 54, 58 are fed to the individual vending mechanisms 26, 28 via partitions 52, 56, respectively, will each preferably be able to accommodate a wide range of bottle sizes, including those depicted in FIG. 4. In this regard, it is contemplated that the vending paths by which containers stored within areas 54, 58 to the individual vending mechanisms 26, 28 will be able to accommodate the bottles referenced in FIG. 70 as having the following standard container sizes, namely, bottle 72, having a cylindrical body portion with a diameter of 1.55 inches and a height of 5.28 inches; bottle 74 having a generally cylindrical configuration with a diameter of 1.466 inches and a height of 4.85 inches; bottle 76 having a cylindrical body portion with a diameter of 1.27 inches and a height of 4.34 inches; bottle 78, having a generally cylindrical configuration with a diameter of 1.53 inches and a height of 3.2 inches and bottle 80 having a generally cylindrical body portion with a diameter of 1.42 inches and a height of 3.35 inches. As will be appreciated by those skilled in the art, such bottle sizes substantially conform to the packaging of currently popular and widely distributed energy-shot beverages. In this regard, it is contemplated that the cooler 10 of the present invention will be sized and configured to not only be readily positioned upon a countertop near a point-of-purchase retail location, the same will further be preferably configured to cool and dispense energy-shot beverages as packaged and marketed according to the bottle configurations 70 depicted in FIG. 4. As will be appreciated by those skilled in the art, there has not heretofore been available a cooler 10 that not only selectively dispenses individual containers of a common product, and much less dedicated vending mechanisms to individually dispense such containers, but also a cooler 10 that is adapted to dispense smaller sized beverage containers, and in particular energy-shot beverages, that typically have smaller sizes and unique marketing, cooling and dispensing requirements.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention. For example, it will be readily understood that while the same is directed to a countertop cooler, the invention need not necessarily be utilized in such a capacity at a point-of-purchase retail location but may be utilized in any capacity where the dispensing of individual containers is desired. Moreover, although discussed in the context of dispensing individual containers of beverages, it should be understood that the cooler 10 of the present invention need not be limited to this specific category, and may be utilized to dispense containers of a wide variety of products and further, that the container need not necessarily be shaped to have a generally cylindrical configuration.

What is claimed is:

1. A compact countertop cooler for dispensing individual container stored within comprising:
a) a housing defining an interior compartment for holding a plurality of containers;
b) a first gravity feed system for selectively and sequentially orienting said containers to be dispensed from said housing;
c) a first vending mechanism comprising a vending chamber coupled to a ratchet mechanism, said vending mechanism being configured and oriented to capture and dispense an individual container from said gravity feed system upon actuation of said ratchet mechanism; and
d) a cooling system coupled to said housing for cooling said interior of said cooler and said containers stored therein.

2. The cooler of claim 1 wherein said cooler further comprises a second gravity feed system and a second vending mechanism, said second vending mechanism comprising a second vending chamber coupled to a second ratchet mechanism, said second vending mechanism being operatively coupled to said second gravity feed system for selectively dispensing an individual container upon actuation of a dedicated ratchet mechanism coupled with said second vending mechanism.

3. The cooler of claim 2 wherein said first gravity feed system and said first vending mechanism are operative to hold and dispense individual containers having a first container size and said second gravity feed system and second vending mechanism are operative to dispense individual containers having a second container size wherein said first container size is dissimilar to said second container size.

4. The cooler of claim 3 wherein said first container size is selected from the group consisting of a generally cylindrical container having a diameter of approximately 1.466 inches and a height of 4.85 inches, a diameter of 1.27 inches and a height of 4.34 inches, a diameter of 1.53 inches and a height of 3.2 inches, a diameter of 1.42 inches and a height of 3.35 inches, and a diameter of 1.55 inches and a height of 5.28 inches and said second container is selected from the group consisting of a generally cylindrical container having a diameter of approximately 1.466 inches and a height of 4.85 inches, a diameter of 1.27 inches and a height of 4.34 inches, a diameter of 1.53 inches and a height of 3.2 inches, a diameter of 1.42 inches and a height of 3.35 inches, and a diameter of 1.55 inches and a height of 5.28 inches, wherein said first container size and said second container size are dissimilar to one another.

5. The cooler of claim 1 wherein said cooling system comprises a thermoelectric heat pump.

6. The cooler of claim 2 wherein said first and second gravity feed systems are defined by first and second rack partitions disposed within said interior of said cooler wherein said first rack partition defines a first storage area for said first containers and said second rack partition defines a second storage area for said second containers.

7. The cooler of claim 1 wherein said ratchet mechanism of said first vending mechanism is operative to selectively isolate and dispense an individual container from said first gravity feed system upon rotation of said ratchet mechanism by 360°.

8. The cooler of claim 2 wherein said ratchet mechanism of said first vending mechanism is operative to isolate and dispense an individual container from said first gravity feed system upon rotation of said first ratchet mechanism by 360° and said ratchet mechanism of said second vending mechanism is operative to isolate and dispense an individual container from said second gravity feed system upon rotation of said ratchet mechanism by 360°.

9. The cooler of claim 7 wherein a perceptible signal is generated upon rotation of said ratchet mechanism.

10. The cooler of claim 8 wherein a perceptible signal is generated upon rotation of said ratchet mechanism of said first vending mechanism and a perceptible signal is generated upon rotation of said ratchet mechanism of said second vending mechanism.

11. A compact countertop cooler for selectively dispensing containers having a first container size and containers having a second container size comprising:
a) a housing;
b) a first rack partition formed in said housing defining a first storage area for said first sized containers and defining a gravity feed path for selectively orienting said first sized containers for dispensation from said housing;
c) a first vending mechanism coupled to said first gravity feed path for receiving dedicated ones of said first size containers, said first vending mechanism comprising a vending chamber operative to receive, isolate and dispense an individual first sized container upon actuation of a first rotatable ratchet mechanism coupled to said vending mechanism; and
d) a second rack partition formed in said housing and defining a storage area for said second sized containers and defining a gravity feed path for selectively orienting said second sized containers for dispensation from said housing;
e) a second vending mechanism coupled to said second gravity feed path for receiving dedicated ones of said second size containers, said second vending mechanism comprising a vending chamber operative to receive, isolate and dispense an individual second sized container upon actuation of a second rotatable ratchet mechanism coupled to said vending mechanism; and
f) a cooler mechanism coupled to said cooler refrigerating the interior of said housing.

12. The cooler of claim 11 further comprising a transparent front window to enable to contents within the interior of said housing to be visual perceived.

13. The cooler of claim 11 wherein said exterior of said housing is operative to receive advertising, logos, product information and decorative indicia.

14. The cooler of claim 11 wherein rotation of said first ratchet mechanism is operative to produce a perceptible signal and said actuation of said second ratchet mechanism is operative to produce a perceptible signal.

15. The cooler of claim 11 wherein said first vending mechanism is operative to capture, isolate and dispense a single first sized container upon rotation of said first ratchet mechanism by 360° and a second vending mechanism is operative to capture, isolate and dispense a single second size container upon rotation of said second ratchet mechanism by 360°.

16. The cooler of claim 11 where said cooling system of said cooler comprises a thermoelectric heat pump.

17. The cooler of claim 11 wherein said cooler further comprises a lid rotatably attached to said housing for allowing said first sized containers and said second sized containers to be loaded within said cooler.

18. The cooler of claim 1 where said ratchet mechanism rotates uni-directionally.

19. The cooler of claim 11 where said first and second ratchet mechanisms rotate uni-directionally.

20. The cooler of claim 11 wherein said first container size is selected from the group consisting of a generally cylindrical container having a diameter of approximately 1.466 inches and a height of 4.85 inches, a diameter of 1.27 inches and a height of 4.34 inches, a diameter of 1.53 inches and a height of 3.2 inches, a diameter of 1.42 inches and a height of 3.35 inches, and a diameter of 1.55 inches and a height of 5.28 inches and said second container is selected from the group consisting of a generally cylindrical container having a diameter of approximately 1.466 inches and a height of 4.85 inches, a diameter of 1.27 inches and a height of 4.34 inches, a diameter of 1.53 inches and a height of 3.2 inches, a diameter of 1.42 inches and a height of 3.35 inches, and a diameter of 1.55 inches and a height of 5.28 inches, wherein said first container size and said second container size are dissimilar to one another.
